(19) United States
(12) Patent Application Publication
(10) Pub. No.: US 2016/0182526 A1
(43) Pub. Date: Jun. 23, 2016

(54) Social network privacy management systems and methods

(71) Applicant: Facebook, Inc., Menlo Park, CA (US)

(72) Inventors: Patrick Underwood, Palo Alto, CA (US); Thomas Witt, Redwood City, CA (US); Alexander Matthew Madjar, San Francisco, CA (US); Jonathon Bradley Paul, San Francisco, CA (US); Justin Thomas Kerekes, Redwood City, CA (US); Charles Donald Deets, JR., Palo Alto, CA (US); Matthew K. Choi, Menlo Park, CA (US); Samuel Leopold Wagner, San Francisco, CA (US)

(21) Appl. No.: 14/998,152

(22) Filed: Dec. 23, 2015

Related U.S. Application Data
(60) Provisional application No. 62/096,443, filed on Dec. 23, 2014.

(51) Int. Cl. H04L 29/06; H04L 29/08

(52) U.S. Cl. CPC H04L 63/105; H04L 67/306

(57) ABSTRACT

A first privacy setting notification is provided to a user. Events are monitored to determine satisfaction of a privacy trigger condition based at least in part on the first privacy setting notification. A second privacy setting notification is provided to the user in response to the satisfaction of the privacy trigger condition.

This application claims priority to U.S. Provisional Patent Application No. 62/096,443, filed on Dec. 23, 2014 and entitled “SOCIAL NETWORK PRIVACY MANAGEMENT SYSTEMS AND METHODS”, which is incorporated herein by reference.

### TECHNICAL FIELD

The technical field relates to the field of social networks. More particularly, the technical field relates to privacy management techniques in social networks.

### BACKGROUND

Social networks provide interactive and content-rich online communities that connect members with one another. Members of social networks may indicate how they are related to one another. For instance, members of a social network may indicate that they are friends, family members, business associates, or followers of one another, or members can designate some other relationship to one another. Social networks often allow members to message each other or post messages to the online community.

Social networks may also allow members to post content. For example, members may create or use pages with interactive feeds that can be viewed across a multitude of platforms. The pages may contain images, video, text, and other content that a member wishes to share with certain members of the social network or to publish to the social network in general. Members may also share content with the social network in other ways. For example, members may publish content to a board or make the content available for searches by the online community.

When sharing content on a social network, users may find it difficult to manage privacy settings. Sometimes, users may not understand the application of privacy settings to their content. Other times, users may share their content with an audience that is larger than intended or to an audience that is smaller than intended.

### SUMMARY

Various embodiments of the present disclosure can include systems, methods, and non-transitory computer readable media configured to provide a first privacy setting notification to a user. Events are monitored to determine satisfaction of a privacy trigger condition based at least in part on the first privacy setting notification. A second privacy setting notification is provided to the user in response to the satisfaction of the privacy trigger condition.

In an embodiment, the satisfaction of the privacy trigger condition is further based at least in part on a threshold time since provision of the first privacy setting notification to the user.

In an embodiment, the satisfaction of the privacy trigger condition is further based at least in part on the user having chosen a first privacy level for prior posts and having chosen a second privacy level for a most recent post.

In an embodiment, the satisfaction of the privacy trigger condition is further based at least in part on the user having changed a privacy level of a post to a second privacy level after the post was published with a first privacy level.

In an embodiment, the satisfaction of the privacy trigger condition is further based at least in part on the user having blocked a threshold number of friend requests over a threshold amount of time from members of a social networking system that are a threshold degree of separation from the user.

In an embodiment, the satisfaction of the privacy trigger condition is further based at least in part on the user having chosen a particular privacy level for posts for a threshold amount of time prior to a current post by the user.

In an embodiment, the satisfaction of the privacy trigger condition is further based at least in part on a user having chosen to proactively perform a privacy checkup to manage privacy settings relating to categories of posts.

In an embodiment, the satisfaction of the privacy trigger condition is further based at least in part on the user having not previously made a post and having not previously set privacy settings.

In an embodiment, the satisfaction of the privacy trigger condition is further based at least in part on the user having chosen to add a new cover photo associated with a page of the user on a social networking system.

In an embodiment, the satisfaction of the privacy trigger condition is further based at least in part on the user likely not selecting privacy levels for posts as intended.

In an embodiment, the satisfaction of the privacy trigger condition is further based at least in part on a post made by the user having appeared in a news feed of the user.

In an embodiment, it is determined that a third privacy setting notification can be provided to the user based on the satisfaction of the privacy trigger condition. The second privacy setting notification is selected instead of the third privacy setting notification for provision to the user based on a hierarchy of privacy setting notifications.

In an embodiment, the first privacy setting notification and the second privacy setting notification are of different types.

In an embodiment, the first privacy setting notification and the second privacy setting notification are of one type.

In an embodiment, a selection from the user received in response to the second privacy setting notification.

In an embodiment, at least one privacy level for a content item is modified based on the selection.

In an embodiment, at least one privacy level for a content item is maintained based on the selection.

In an embodiment, the user is a member of a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 shows an example privacy management system, in accordance with some embodiments.

FIGS. 2A-2B shows example diagrams of methods for managing privacy, in accordance with some embodiments.

FIGS. 3-8 show example screens relating to privacy mangement, in accordance with some embodiments.

FIG. 9 is a network diagram of an example social networking environment in which to implement the elements of the tag prediction system, in accordance with some embodiments.

FIG. 10 shows an example diagram of a computer system that may be used to implement one or more of the embodiments described herein in accordance with some embodiments.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles described herein.

### DETAILED DESCRIPTION

### Social Networking Privacy Management Systems and Methods

A social networking system may provide users with the ability to generate content and share it with friends. Users of a social networking system may enjoy capturing images (e.g., still images, memes), video, or interactive content on their mobile phones and sharing the content with their online friends. Similarly, users may enjoy sharing content, such as text, images, or video, by posting them on their homepage.

Sometimes, users of a social networking system may inadvertently share content or show profile information to the wrong set of users. For example, users may take actions that they think are visible only to a smaller audience (e.g., close friends or specific connections) but may in fact be visible to a larger audience (e.g., a larger group of friends or the general public). It would be helpful to provide systems and methods to allow users of the social networking system to better ensure that their postings are shared with the intended audience.

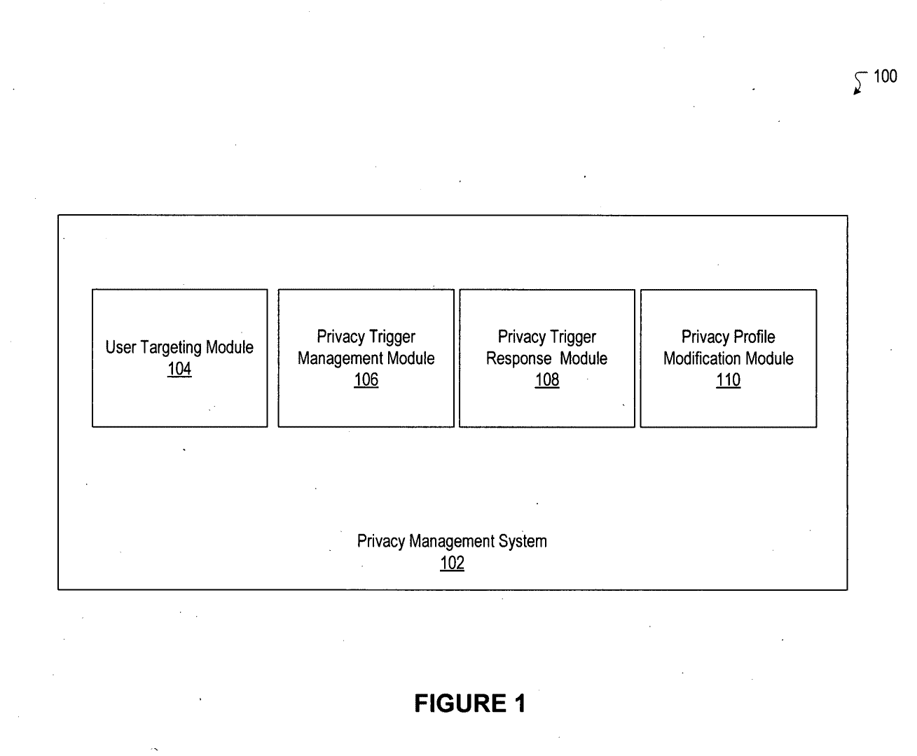

FIG. 1 shows an example diagram 100 of a privacy management system 102, in accordance with some embodiments. The privacy management system 102 may allow users to manage privacy settings to minimize the oversharing (or undersharing) of content and/or personal information. By reducing the oversharing (or undersharing) of private information with unintended audiences, the privacy management system 102 may ensure users' privacy settings are in line with their expectations. The privacy management system 102 includes a user targeting module 104, a privacy trigger management module 106, a privacy trigger response module 108, and a privacy profile modification module 110. The components (e.g., modules, elements, etc.) shown in this figure and all figures herein are exemplary only, and other implementations may include additional, fewer, integrated, or different components. Some components may not be shown so as not to obscure relevant details. One or more of the user targeting module 104, the privacy trigger management module 106, the privacy trigger response module 108, and the privacy profile modification module 110 may be coupled to one another or to modules not explicitly shown in FIG. 1.

The privacy management system 102 can account for user behavior across different platforms (e.g., native applications, mobile applications, web browser applications, etc.) and provide privacy setting notifications across different platforms in response to user behavior across the different platforms. The privacy management system 102 also can receive from different platforms information from users in response to the privacy setting notifications. The ability of the privacy management system 102 to operate across platforms provides versatility in ensuring that a user can optimize privacy management in different computing and use environments.

The user targeting module 104 may be configured to identify users of a social networking system to target for privacy management based on targeting factors. One example of targeting factors includes factors related to the length of time specific users have been members of the social networking system to target for privacy management. For instance, the user targeting module 104 may identify specific users who have been members of the social networking system for longer than a predetermined threshold of time. Another example of targeting factors includes factors related to how recently specific users have accessed an account of the social networking system. For instance, specific users may be targeted for privacy management based on the fact that they logged on to social networking system accounts since a threshold amount of time ago (e.g., the last day, last week, last month, last several months, last year, etc.). Still another example of targeting factors includes factors related to attributes of profiles of specific users. For instance, only those users who have chosen to share certain fields of personal information (e.g., telephone numbers, names, email addresses, mailing addresses, relationship statuses, specific relationships, etc.) over the social networking system may be targeted for privacy management.

Yet another example of targeting factors includes factors related to the length of time since a specific user last received a privacy setting notification from the privacy management system 102. A privacy setting notification can include information, references, questions, prompts, corrective actions, or the like regarding management of privacy settings. For example, the user targeting module 104 may select for receipt of a privacy setting notification only users who have not received any type of privacy setting notification from the privacy management system 102 since a threshold amount of time. As another example, the user targeting module 104 may select for receipt of a specific type of privacy setting notification only users who have not received certain types of privacy setting notifications since a threshold amount of time. For instance, the user targeting module 104 may select for receipt of a first type of privacy setting notification only users who have not received a second type, third type, or sixth type of privacy setting notification since a threshold amount of time. As yet another example, the user targeting module 104 may select for receipt of a specific type of privacy setting notification only users who have not received the specific type of privacy setting notification since a threshold amount of time. The types of privacy setting notifications can include the privacy setting notifications associated with various aspects of privacy management discussed in more detail herein. Threshold amounts of time can be any suitable values, and can vary based on circumstances. The threshold amounts of time can be selected based on the types of privacy setting notifications.

The privacy trigger management module 106 may receive events indicating user behavior on the social networking system and determine satisfaction of privacy trigger conditions. In some instances, privacy trigger conditions may include conditions related to events that suggest a user may be sharing content with an audience other than the user's intended audience. A privacy trigger condition can be based on one or a combination of events. Events can include any action (or nonaction) taken (or not taken) by a user or other members of the social networking system. The privacy trigger management module 106 can account for events that take place across different platforms.

Types of privacy trigger conditions can vary. In a first example, a type of privacy trigger condition can be based on whether a user has chosen a first privacy level for posts in the past and has chosen a second privacy level for a most recent post. In a second example, a type of privacy trigger condition can be based on whether a user has changed the privacy level of a post to a second privacy level after the post was published with a first privacy level. In a third example, a type of a privacy trigger condition can be based on whether a user has blocked a threshold number of friend requests over a threshold amount of time from members of the social networking system that are a threshold degree of separation from the user. In a fourth example, a type of a privacy trigger condition can be based on whether a user has consistently chosen a particular privacy level (e.g., public audience) for posts for a threshold amount of time prior to a current post by the user. In a fifth example, a type of privacy trigger condition can be based on whether a user has chosen to proactively perform a privacy checkup to manage privacy settings relating to various categories of posts. In a sixth example, a type of privacy trigger condition can be based on whether a user has not previously made a post and has not previously set privacy settings. In a seventh example, a type of privacy trigger condition can be based on whether a user has chosen to add a new cover photo associated with a page of the user on a social networking system. In an eighth example, a type of privacy trigger condition can be based on whether a user is likely selecting privacy levels for posts as intended or is likely not selecting privacy levels for posts as intended. In a ninth example, a type of privacy trigger condition can be based on whether a post made by a user has appeared in a news feed of the user. The foregoing example types of privacy trigger conditions are associated with various aspects of privacy management discussed in more detail herein.

Many other variations and other examples of privacy trigger conditions are possible. For example, one or more of the foregoing example privacy trigger conditions can be additionally based on a requirement that the user be a member of a social networking system for a threshold amount of time (e.g., one year). As another example, one or more of the foregoing example privacy trigger conditions can be additionally based on a requirement that the user has not otherwise proactively attempted to manage privacy settings through pages dedicated to the management of privacy settings since a threshold amount of time. As yet another example, one or more of the foregoing example privacy trigger conditions can be additionally based on a requirement that the user has not previously taken action in response to a previous privacy setting notification that was provided to the user based on satisfaction of the same one or more privacy trigger conditions.

The privacy trigger response module 108 may identify privacy setting notifications for users based on satisfaction of privacy trigger conditions. The privacy setting notifications may include information about the current state of a user's privacy. For example, the information may include how much of a user's profile and/or the specific fields of a user's profile, is visible to specific groups of other users (e.g., friends, friends of friends, third degree connections, the public, etc.) and may include a default level of privacy for content that the user will share. The privacy setting notifications also may include recommended actions to be taken by the user or a recommendation of a specific privacy level for specific content. The privacy setting notifications may be provided to a user in the form of user interface elements, such as pop-up windows, notifications, wizards, or the like.

The privacy setting notifications also may include options for the user to confirm, select, or change privacy levels of content and profile information, or take other remedial actions. For example, the privacy setting notifications may include requests to confirm whether a user wants to post content to a specific album associated with a privacy level, whether the user wants to post content at a specific privacy level, whether the user wants to share content with specific users and/or groups of users, whether the user wants to change a current privacy level of content, etc. As another example, the privacy setting notifications may include options for the user to select or change privacy settings for content from a less restrictive privacy level to a more restrictive privacy level. As yet another example, the privacy setting notifications can include options to take remedial (or corrective) actions, such as blocking future friend requests from specific users or specific groups of users (e.g., third degree connections, the public, etc.).

In some embodiments, the privacy trigger response module 108 may determine that one or more privacy setting notifications can be provided to a user based on the satisfaction of one or more privacy trigger conditions. The privacy trigger response module 108 can provide privacy setting notifications based on the satisfaction of related privacy trigger conditions. The privacy setting notifications can be provided to any one of various platforms.

In some embodiments, the privacy trigger response module 108 may selectively not provide privacy setting notifications when associated privacy trigger conditions are otherwise satisfied. For example, if the privacy response module 108 determines the presence of indicia that the user has been selecting privacy levels for posts as intended, privacy setting notifications may not be provided. Such indicia can include any information that is suggests privacy settings are being correctly managed by the user. For example, such indicia can be based on a history of different privacy levels selected by the user for posts, one or more responses by the user to privacy setting notifications, a demographic attribute of the user, etc.

In some embodiments, when a plurality of privacy setting notifications can be potentially provided to a user, the privacy trigger response module 108 can selectively provide one or more of the plurality of the privacy setting notifications based on a hierarchy of privacy setting notifications. The hierarchy can be based on an order of importance of privacy setting notifications and on chronological factors. For example, if a first type of privacy setting notification and a second type of privacy setting notification both can be provided to the user, the first type of privacy setting notification instead of the second type of privacy setting notification can be provided to the user when the hierarchy specifies that the first type of privacy setting notification is more important than the second type of privacy setting notification. As another example, if a first type of privacy setting notification and a second type of privacy setting notification both can be provided to the user, the second type of privacy setting notification instead of the first type of privacy setting notification can be provided to the user when the hierarchy specifies that the first type of privacy setting notification should not be provided because the first type of privacy setting notification was provided to the user within a threshold amount of time. In this example, the second type of privacy setting notification instead of the first type of privacy setting notification can be provided to the user even if the hierarchy specifies that the first type of privacy setting notification is more important than the second type of privacy setting notification.

The privacy profile modification module 110 may receive modifications to privacy settings and may implement these modifications to the user's profile in the social networking system. In various embodiments, the privacy profile modification module 110 receives responses to privacy setting notifications provided by the privacy trigger response module 108, and updates the user's privacy profile accordingly. In some embodiments, the privacy profile modification module 110 may not change privacy settings when the user has indicated that no changes to privacy settings are desired.

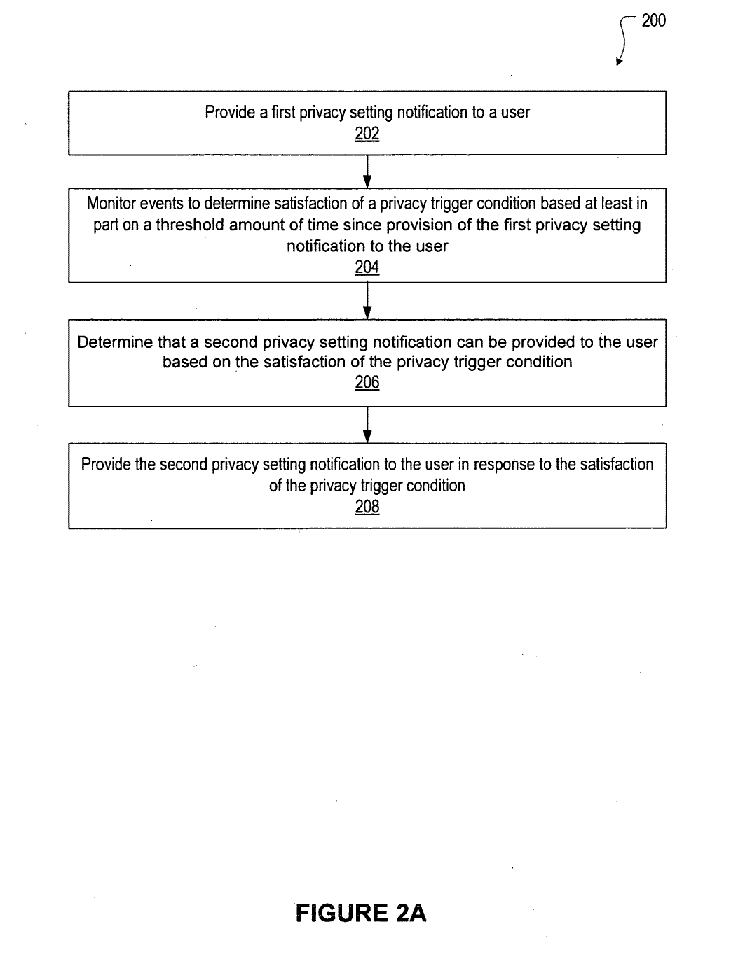

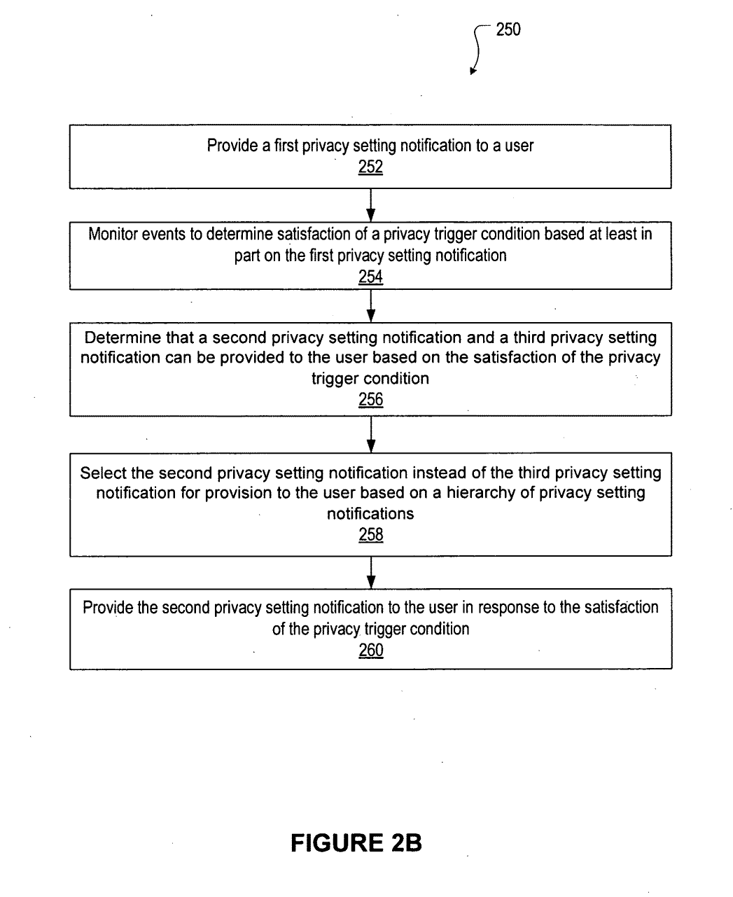

FIG. 2A shows an example method 200 for managing privacy settings, in accordance with some embodiments. The process can be performed by the privacy management system 102. At block 202, the method 200 can provide a first privacy setting notification to a user. At block 204, the method 200 can monitor events to determine satisfaction of a privacy trigger condition based at least in part on a threshold amount of time since provision of the first privacy setting notification to the user. At block 206, the method 200 can determine that a second privacy setting notification can be provided to the user based on the satisfaction of the privacy trigger condition. At block 208, the method 200 can provide the second privacy setting notification to the user in response to the satisfaction of the privacy trigger condition. Many variations incorporating the embodiments and features described herein are possible.

FIG. 2B shows an example method 250 for managing privacy settings, in accordance with some embodiments. The process can be performed by the privacy management system 102. At block 252, the method 250 can provide a first privacy setting notification to a user. At block 254, the method 250 can monitor events to determine satisfaction of a privacy trigger condition based at least in part on the first privacy setting notification. At block 256, the method 250 can determine that a second privacy setting notification and a third privacy setting notification can be provided to the user based on the satisfaction of the privacy trigger condition. At block 258, the method 250 can select the second privacy setting notification instead of the third privacy setting notification for provision to the user based on a hierarchy of privacy setting notifications. At block 260, the method 250 can provide the second privacy setting notification to the user in response to the satisfaction of the privacy trigger condition. Many variations incorporating the embodiments and features described herein are possible.

### Aspects of Privacy Management

The privacy management system 102 may support different aspects of privacy management. Each aspect of privacy management can be associated with a corresponding type of targeting factors, trigger condition, and/or privacy setting notification. Several example aspects of privacy management are further discussed herein. Many variations and other examples of aspects of privacy management are possible.

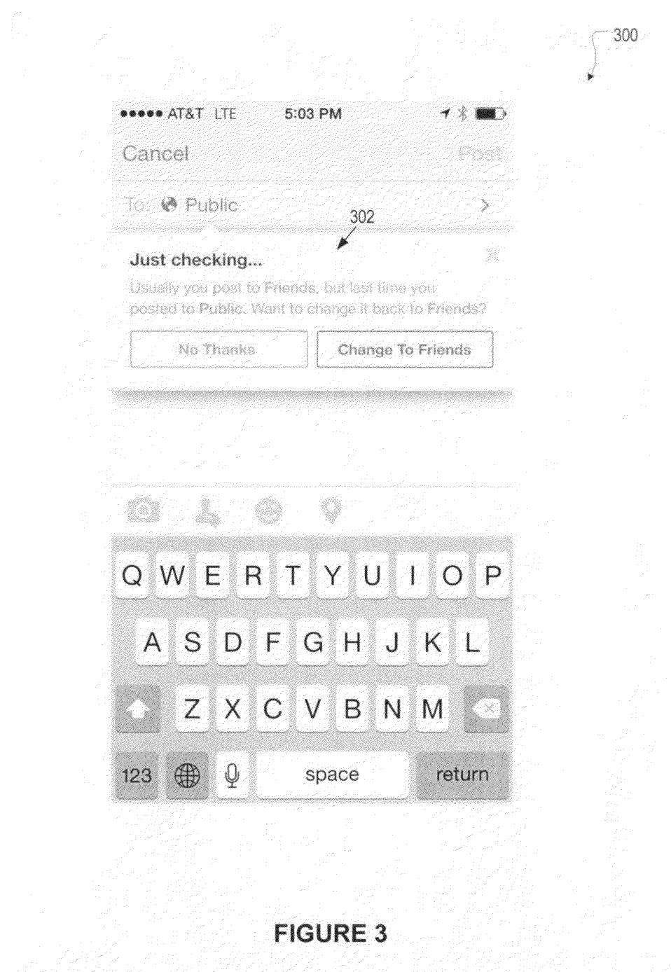

In accordance with a first aspect of privacy management, the privacy management system 102 may determine whether a user has chosen a first privacy level for posts in the past and has chosen a second privacy level for a most recent post. The posts in the past may be a threshold number of posts or may be posts that occurred over a threshold amount of time. In some embodiments, the second privacy level is less restrictive than the first privacy level. Upon determination that the user has chosen a first privacy level for posts in the past and has chosen a second privacy level for a most recent post, the privacy management system 102 may provide a type of privacy setting notification that asks the user whether the user desires to apply the first privacy level for the next post, as shown in FIG. 3.

FIG. 3 shows an example screen 300 of a mobile application that facilitates managing changes to privacy settings for content, in accordance with some embodiments. The screen 300 displays a privacy setting notification that includes a user interface element 302. The user interface element 302 may appear based on a determination that the user has chosen a more restrictive privacy level for posts in the past and has chosen a less restrictive privacy level for a most recent post. The user interface element 302 asks the user for confirmation that the user intends to post to a less restrictive audience. The user interface element 302 also provides the options to continue to post to a more restrictive audience (e.g., friends audience).

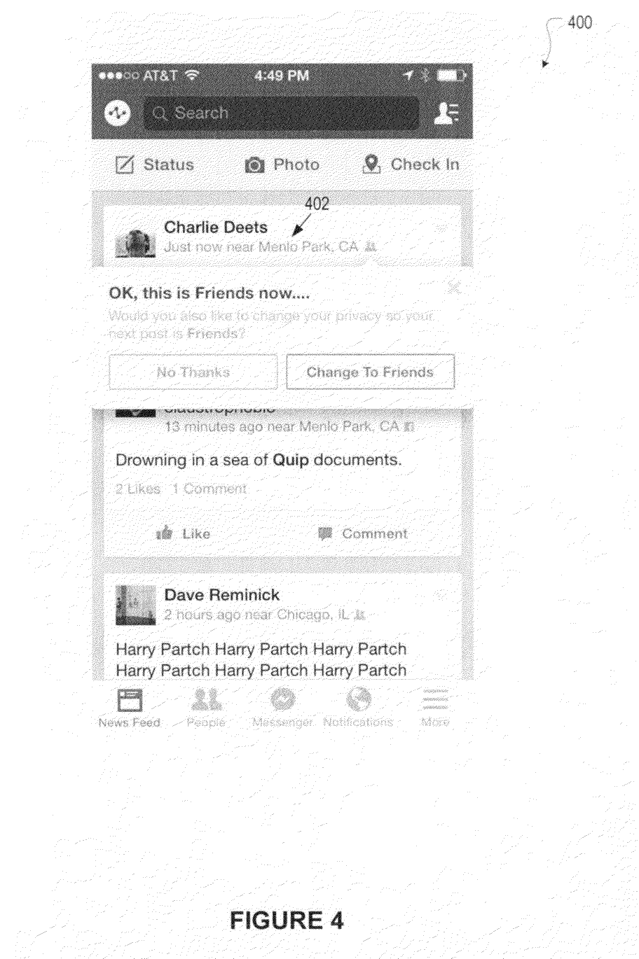

In accordance with a second aspect of privacy management, the privacy management system 102 may determine whether a user has changed the privacy level of a post to a second privacy level after the post was published with a first privacy level. In some embodiments, the second privacy level is more restrictive than the first privacy level. Upon determination that the user has changed the privacy level of a post to a second privacy level after the post was published with a first privacy level, the privacy management system 102 may provide a type of privacy setting notification that asks the user whether the second privacy level should be applied to a next post by the user, as shown in FIG. 4.

FIG. 4 shows an example screen 400 of a mobile application that facilitates managing changes to privacy settings for content, in accordance with some embodiments. The screen 400 displays a privacy setting notification that includes a user interface element 402. The user interface element 402 may appear based on a determination that the user has changed the privacy level of a post to a more restrictive privacy level after the post was published with a more restrictive privacy level. The user interface element 402 can provide the user with the option to change future posts to the more restrictive privacy level.

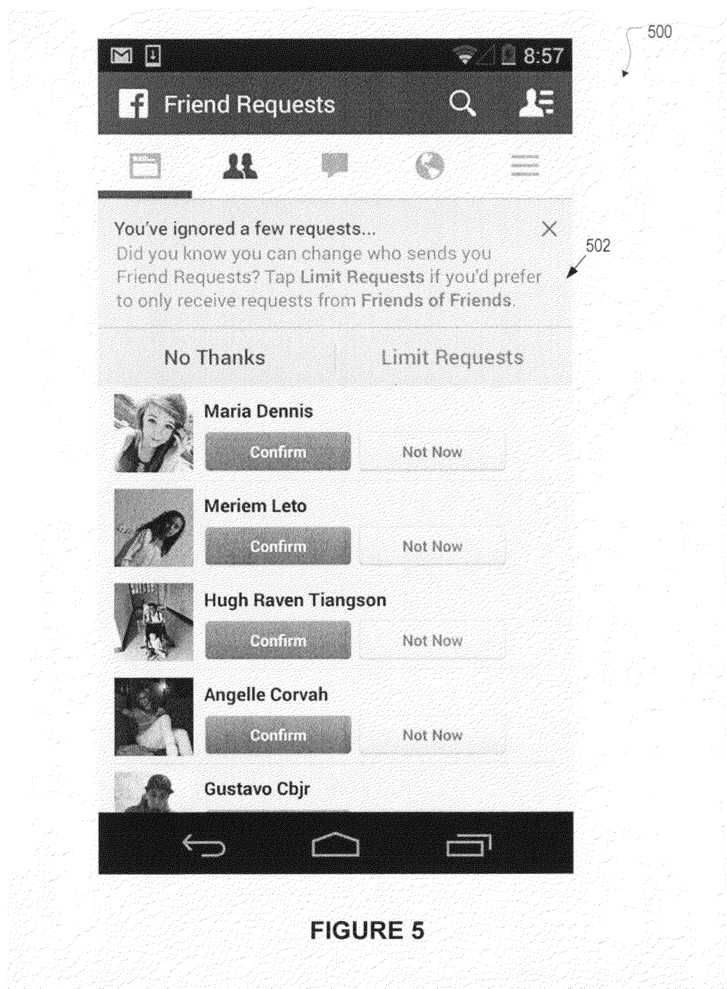

In accordance with a third aspect of privacy management, the privacy management system 102 may determine whether a user has blocked a threshold number of friend requests over a threshold amount of time from members of the social networking system that are a threshold degree of separation from the user. The threshold number of previously block friend requests can be any suitable number (e.g., four). The threshold amount of time can be any suitable amount of time (e.g., one month). The threshold degree of separation from the user can be any suitable degree (e.g., three degrees). Upon determination that the user has blocked a threshold number of friend requests over a threshold amount of time from members of the social networking system that are a threshold degree of separation from the user, the privacy management module 102 may provide a type of privacy setting notification that asks the user if future friend requests from members of the social networking system that are or exceed a threshold degree of separation from the user should be blocked so that the user is not presented with such friend requests, as shown in FIG. 5.

FIG. 5 shows an example screen 500 of a mobile application that facilitates managing privacy settings related to friend requests, in accordance with some embodiments. The screen 500 displays a privacy setting notification that includes a user interface element 502. The user interface element 502 may appear based on a determination that the user has blocked four friend requests over a threshold amount of time from members of the social networking system that are three or more degrees of separation from the user. The user interface element 502 provides the user with the option to block all future friend requests from such members of the social networking system.

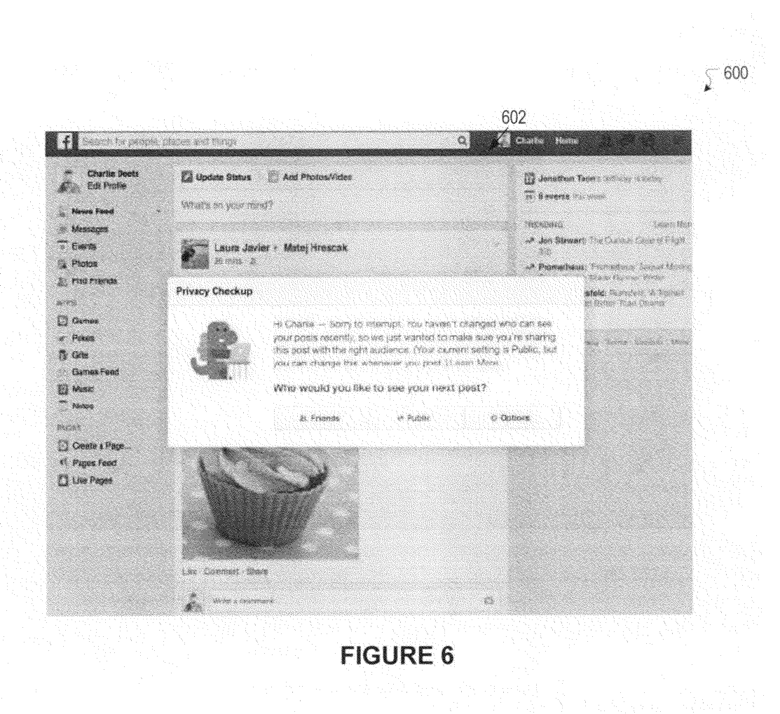

In accordance with a fourth aspect of privacy management, the privacy management system 102 may determine whether a user has chosen a particular privacy level (e.g., public audience) for all posts for a threshold amount of time prior to a current post by the user. The threshold amount of time can be any suitable amount of time (e.g., one month). Upon determination that the user has chosen a particular privacy level for all posts for a threshold amount of time, the privacy management module 102, for the current post, may provide a type of privacy setting notification that informs the user that she has not changed the privacy level for posts during a time period and that asks the user to select a privacy level from a selection of privacy level options, such as public audience, friends audience, and other options, as shown in FIG. 6.

FIG. 6 shows an example screen 600 of a web browser displaying a social networking application that facilitates managing changes to privacy settings related to content, in accordance with some embodiments. The screen 600 displays a privacy setting notification that includes a user interface element 602. The user interface element 602 may appear based on a determination that the user has chosen a privacy level of public audience for posts for a threshold amount of time. The user interface element 602 provides the user with the option to select a privacy level from a selection of privacy level options, such as public audience, friends audience, and other options.

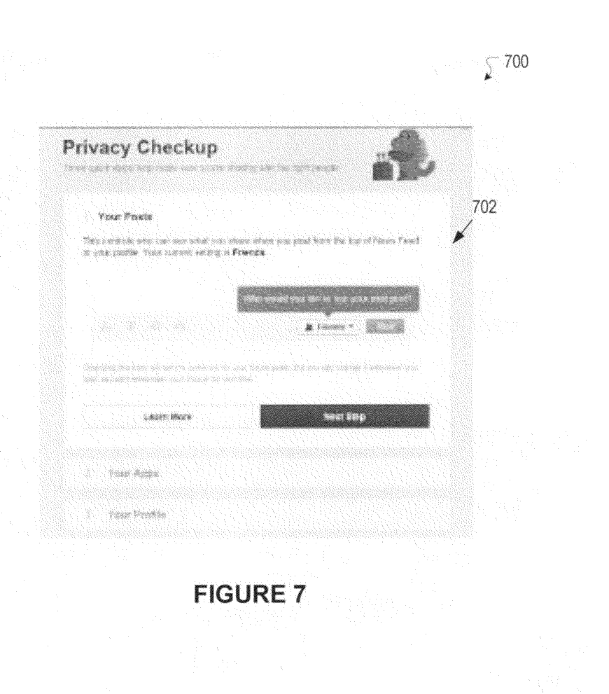

In accordance with a fifth aspect of privacy management, the privacy management system 102 may determine whether a user has proactively chosen to perform a privacy checkup to manage privacy settings relating to various categories of posts and profile information. Categories of posts and profile information can include posts of the user on the social networking system, activity of the user in connection with applications integrated with the social networking system, and profile information about the user. Posts of the user on the social networking system may include posts made to the news feed of the user. Activity of the user in connection with applications integrated with the social networking system may include posts that the application makes for the user and visibility by others into what applications that the user uses. Profile information about the user may include email addresses, birthday, interests, residential address, etc. In some embodiments, the privacy management system 102 can display a type of privacy setting notification that includes certain fields of information in certain categories and prompt the user to maintain or change privacy levels for such fields of information, as shown in FIG. 7. In some embodiments, a threshold subset of fields (e.g., four) from a larger set of fields (e.g., thirty) associated with a category (e.g., profile information) can be presented to the user for privacy management.

FIG. 7 shows an example screen 700 of a web browser displaying a social networking application that facilitates managing changes to privacy settings related to content, in accordance with some embodiments. The screen 700 displays a privacy setting notification that includes a user interface element 702. The user interface element 702 may appear based on user selection of a button to allow management of privacy settings. The user interface element 702 provides the user to change privacy levels for categories of information, including posts of the user on a social networking system, activity of the user in connection with applications integrated with the social networking system, and profile information about the user.

In accordance with a sixth aspect of privacy management, the privacy management system 102 may determine whether a user has not previously made a post and has not previously set privacy settings. Upon a determination that the user has not previously made a post and has not previously set privacy settings, the privacy management module 102 may provide a type of privacy setting notification that asks the user to select a privacy level from a selection of privacy level options, such as public audience, friends audience, and other options.

In accordance with a seventh aspect of privacy management, the privacy management system 102 may determine whether a user has chosen to add a new cover photo associated with a page of the user on a social networking system. Upon a determination that the user has chosen to add a new cover photo associated with a page of the user on a social networking system, the privacy management module 102 may provide a type of privacy setting notification that allows the user to change the privacy settings of prior cover photos of the user.

In accordance with an eighth aspect of privacy management, the privacy management system 102 may determine whether a user is likely selecting privacy levels for posts as intended or is likely not selecting privacy levels for posts as intended. A user likely selecting privacy levels for posts as intended and a user not likely selecting privacy levels as intended can be identified by a variety of considerations. For example, a user who regularly varies privacy levels for posts is likely to be selecting privacy levels as intended. As another example, a relatively new user who has a modest history of posting and who has not made privacy level changes is likely not to be selecting privacy levels as intended. As yet another example, a user whose stated intent regarding privacy level is aligned with her actual selection of privacy levels is likely to be selecting privacy levels as intended. Upon determination that the user is likely selecting privacy levels for posts as intended, the privacy management system 102 may provide a type of privacy setting notification that indicates the privacy level for posts usually chosen by the user and informs that the privacy level will be applied as a default privacy level for future posts of the user. Upon determination that the user is likely not selecting privacy levels for posts as intended, the privacy management system 102 may provide a type of privacy management setting notification that prompts the user to select her favorite privacy level and informs the user that the selected favorite privacy level will be applied as a default privacy level for future posts of the user.

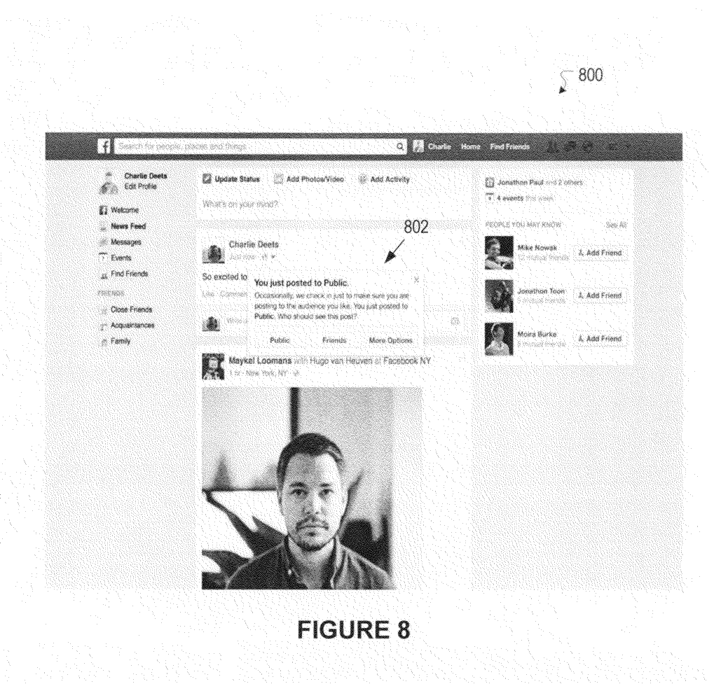

In accordance with a ninth aspect of privacy management, the privacy management system 102 may determine that a post having a privacy level (e.g., public audience) made by a user has appeared in a news feed of the user. Upon determination that a post made by the user has appeared in a news feed of the user, the privacy management system 102 may provide a type of privacy setting notification that asks the user to select a privacy level from a selection of privacy level options, such as public audience, friends audience, and other options, as shown in FIG. 8.

In some embodiments, the user may be randomly selected from a larger group of users who selected a privacy level (e.g., public audience) for posts that appeared in the news feeds of the users. If, in response to the privacy setting notification, the user selects a privacy level that is the same as the actual privacy level for the post, the privacy management system 102 may determine that the actual privacy level for the post is aligned with the intended privacy level for the post. If, in response to the privacy setting notification, the user selects a privacy level that is not the same as the actual privacy level for the post, the privacy management system 102 may determine that the actual privacy level for the post is misaligned with the intended privacy level for the post. In response to a determination of misalignment, the privacy management system 102 may set the privacy setting of the post to the selected privacy level and provide a privacy setting notification that asks the user if the selected privacy level should be applied to future posts.

FIG. 8 shows an example screen 800 of a web browser displaying a social networking application that facilitates managing changes to privacy settings related to content, in accordance with some embodiments. The screen 800 displays a privacy setting notification that includes a user interface element 802. The user interface element 802 may appear based on a determination that a post having a privacy level of public audience made by a user has appeared in a news feed of the user. The user interface element 802 provides the user with an ability to select a privacy level from a selection of privacy level options, such as public audience, friends audience, and other options.

The privacy management system 102 may maintain, set, or change privacy settings to privacy levels desired by the user, as reflected in responses to the provision of privacy setting notifications in connection with any of the aspects of privacy management, as discussed herein.

### Social Networking System—Example Implementation

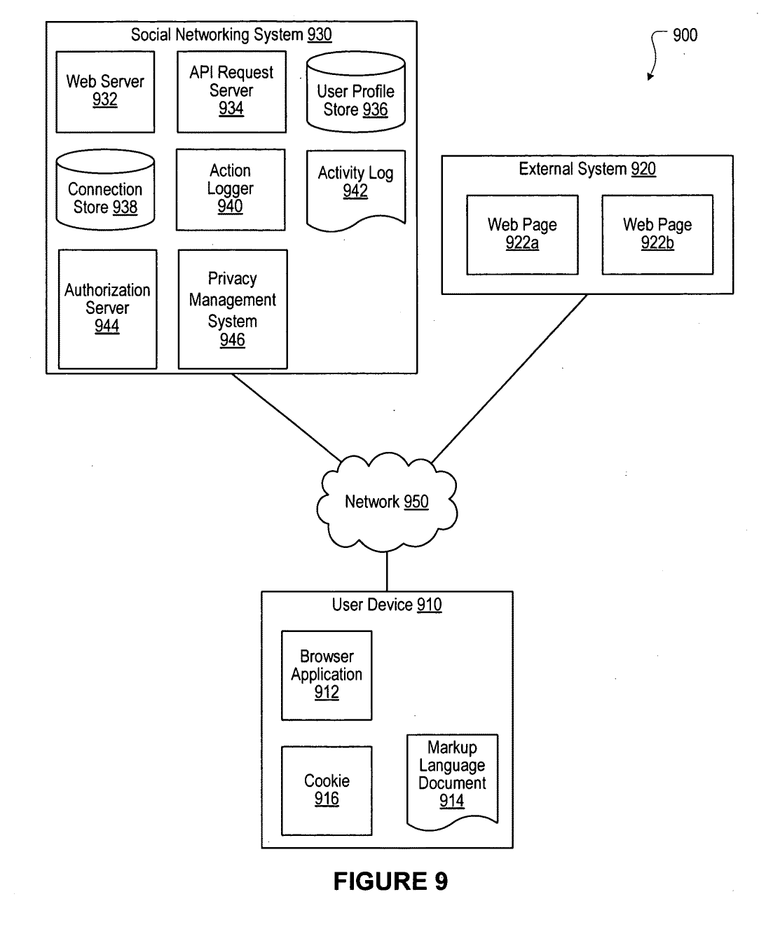

FIG. 9 is a network diagram of an example social networking environment 900 in which to implement the elements of the privacy management system 102, in accordance with some embodiments. The social networking environment 900 includes one or more user devices 915, one or more external systems 920, a social networking system 930, and a network 950. In an embodiment, the social networking system discussed in connection with the embodiments described above may be implemented as the social networking system 930. For purposes of illustration, the embodiment of the social networking environment 900, shown by FIG. 9, includes a single external system 920 and a single user device 915. However, in other embodiments, the social networking environment 900 may include more user devices 915 and/or more external systems 920. In certain embodiments, the social networking system 930 is operated by a social networking system provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 915 comprises one or more computing devices that can receive input from a user and transmit and receive data via the network 950. In one embodiment, the user device 915 is a conventional computer system executing, for example, a Microsoft Windows compatible operating system (OS), Apple OS X, and/or a Linux distribution. In another embodiment, the user device 915 can be a device having computer functionality, such as a smart-phone, a tablet, a personal digital assistant (PDA), a mobile telephone, etc. The user device 915 is configured to communicate via the network 950. The user device 915 can execute an application, for example, a browser application that allows a user of the user device 915 to interact with the social networking system 930. In another embodiment, the user device 915 interacts with the social networking system 930 through an application programming interface (API) provided by the native operating system of the user device 915, such as iOS and ANDROID. The user device 915 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec). In various embodiments, the network 950 may be implemented as the network 950.

In one embodiment, the user device 915 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 915. The browser application 912 on the user device 915 may use a JavaScript compiler to decode the markup language document 914. In an embodiment, the user device 915 may include a client application module 918. The client application module 918 may be implemented as the client application module 114.

The markup language document 914 may also include, or link to, applications or application frameworks such as FLASH™ or Unity™ applications, the SilverLight™ application framework, etc.

In one embodiment, the user device 915 also includes one or more cookies 916 including data indicating whether a user of the user device 915 is logged into the social networking system 930, which may enable modification of the data communicated from the social networking system 930 to the user device 915.

The external system 920 includes one or more web servers that include one or more web pages 922a, 922b, which are communicated to the user device 915 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content. The external system may also include content module(s) 924, as described in more detail herein. In various embodiments, the content module(s) 924 may be implemented as the content module(s) 92.

The social networking system 930 includes one or more computing devices for a social networking system, including a plurality of users, and providing users of the social networking system with the ability to communicate and interact with other users of the social networking system. In some instances, the social networking system can be represented by a graph, i.e., a data structure including edges and nodes. Other data structures can also be used to represent the social networking system, including but not limited to databases, objects, classes, Meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system. 930. An edge between two nodes in the social graph may represent a particular kind of connection, or association, between the two nodes, which may result from node relationships or from an action that was performed by one of the nodes on the, other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 915. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, an authorization server 944, a privacy management system 946, and content system(s) 948. In an embodiment, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 915 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 915. The messages can be instant messages, queued messages (e.g., email), text and SMS messages, or any other suitable messaging format.

The API request server 934 allows one or more external systems 920 and user devices 915 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 420. In another embodiment, the user device 915 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

The social networking system 930 may include the privacy management system 946. In an embodiment, the privacy management system 946 may be implemented as the privacy management system 102, shown in FIG. 1 and discussed further herein.

### Hardware Implementation

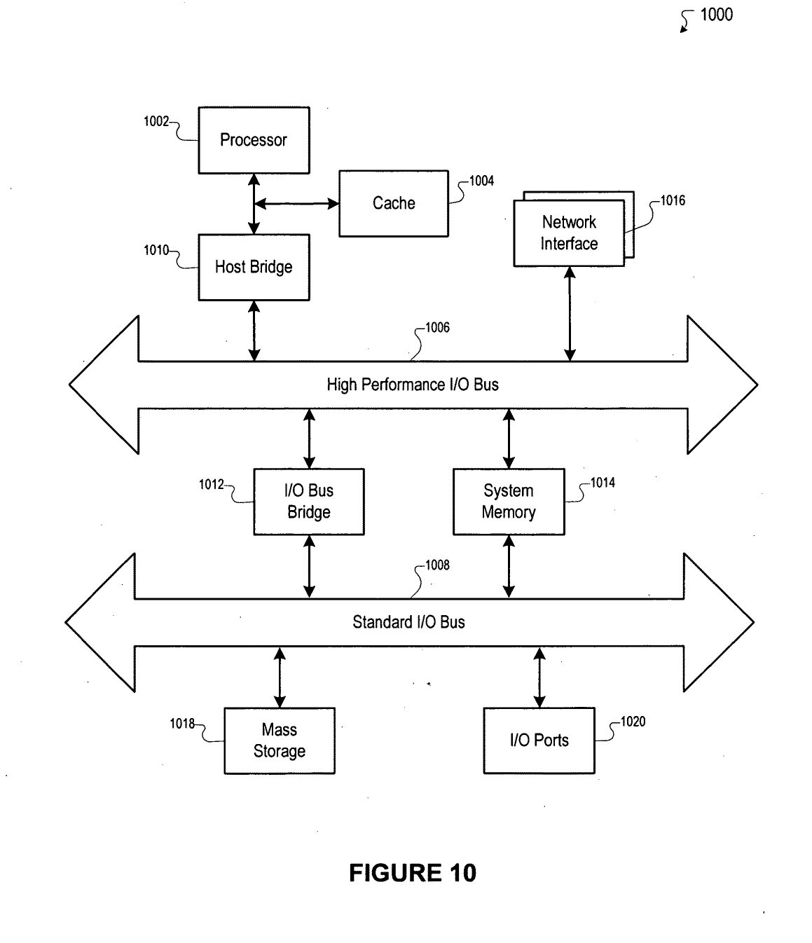

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment, the computer system 1000 may reside with the social networking system 930, the device 610, and the external system 620, or a component thereof. In an embodiment, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1016 couples processor 1002 to high performance I/O bus 1006, whereas I/O bus bridge 1012 couples the two buses 1006 and 1008 to each other. A system memory 1014 and a network interface 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the −86-compatible processors manufactured by Intel Corporation of Santa Clara, Calif., and the −86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Furthermore, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

What is claimed:

1. A computer implemented method comprising:
providing, by a computing system, a first privacy setting notification to a user;
monitoring, by the computing system, events to determine satisfaction of a privacy trigger condition based at least in part on the first privacy setting notification; and providing, by the computing system, a second privacy setting notification to the user in response to the satisfaction of the privacy trigger condition.

2. The computer-implemented method of claim 1, wherein the satisfaction of the privacy trigger condition is further based at least in part on a threshold amount of time since provision of the first privacy setting notification to the user.

3. The computer-implemented method of claim 1, wherein the satisfaction of the privacy trigger condition is further based at least in part on the user having chosen a first privacy level for prior posts and having chosen a second privacy level for a most recent post.

4. The computer-implemented method of claim 1, wherein the satisfaction of the privacy trigger condition is further based at least in part on the user having changed a privacy level of a post to a second privacy level after the post was published with a first privacy level.

5. The computer-implemented method of claim 1, wherein the satisfaction of the privacy trigger condition is further based at least in part on the user having blocked a threshold number of friend requests over a threshold amount of time from members of a social networking system that are a threshold degree of separation from the user.

6. The computer-implemented method of claim 1, wherein the satisfaction of the privacy trigger condition is further based at least in part on the user having chosen a particular privacy level for posts for a threshold amount of time prior to a current post by the user.

7. The computer-implemented method of claim 1, wherein the satisfaction of the privacy trigger condition is further based at least in part on a user having chosen to proactively perform a privacy checkup to manage privacy settings relating to categories of posts.

8. The computer-implemented method of claim 1, wherein the satisfaction of the privacy trigger condition is further based at least in part on the user having not previously made a post and having not previously set privacy settings.

9. The computer-implemented method of claim 1, wherein the satisfaction of the privacy trigger condition is further based at least in part on the user having chosen to add a new cover photo associated with a page of the user on a social networking system.

10. The computer-implemented method of claim 1, wherein the satisfaction of the privacy trigger condition is further based at least in part on the user likely not selecting privacy levels for posts as intended.

11. The computer-implemented method of claim 1, wherein the satisfaction of the privacy trigger condition is further based at least in part on a post made by the user having appeared in a news feed of the user.

12. The computer-implemented method of claim 1, further comprising:
determining that a third privacy setting notification can be provided to the user based on the satisfaction of the privacy trigger condition; and
selecting the second privacy setting notification instead of the third privacy setting notification for provision to the user based on a hierarchy of privacy setting notifications.

13. The computer-implemented method of claim 1, wherein the first privacy setting notification and the second privacy setting notification are of different types.

14. The computer-implemented method of claim 1, wherein the first privacy setting notification and the second privacy setting notification are of one type.

15. The computer-implemented method of claim 1, further comprising:
receiving a selection from the user in response to the second privacy setting notification.

16. The computer-implemented method of claim 1, further comprising:
modifying at least one privacy level for a content item based on the selection.

17. The computer-implemented method of claim 1, further comprising:
maintaining at least one privacy level for a content item based on the selection.

18. The computer-implemented method of claim 1, wherein the user is a member of a social networking system.

19. A system comprising:
at least one processor;
a memory storing instructions configured to instruct the at least one processor to perform:
providing a first privacy setting notification to a user;
monitoring events to determine satisfaction of a privacy trigger condition based at least in part on the first privacy setting notification; and
providing a second privacy setting notification to the user in response to the satisfaction of the privacy trigger condition.

20. A computer storage medium storing computer-executable instructions that, when executed, cause a computer system to perform a computer-implemented method comprising:
providing a first privacy setting notification to a user;
monitoring events to determine satisfaction of a privacy trigger condition based at least in part on the first privacy setting notification; and
providing a second privacy setting notification to the user in response to the satisfaction of the privacy trigger condition.
